(19) United States
(12) Patent Application Publication
(10) Pub. No.: US 2024/0396052 A1
(43) Pub. Date: Nov. 28, 2024

(54) CATHODE COMPOSITE, MANUFACTURING METHOD OF THE SAME AND ELECTROCHEMICAL CELL COMPRISING THE SAME

(71) Applicant: KOREA INSTITUTE OF SCIENCE AND TECHNOLOGY, Seoul (KR)

(72) Inventors: Kyung Joong YOON, Seoul (KR); Mi Young PARK, Seoul (KR); Sun-Young PARK, Seoul (KR); Sungeun YANG, Seoul (KR); Deok-Hwang KWON, Seoul (KR); Ho ll JI, Seoul (KR); Hyoungchul KIM, Seoul (KR); Ji-Won SON, Seoul (KR); Jong Ho LEE, Seoul (KR); Byung Kook KIM, Seoul (KR)

(21) Appl. No.: 18/535,153

(22) Filed: Dec. 11, 2023

(30) Foreign Application Priority Data
May 26, 2023 (KR) 10-2023-0068478

(51) Int. Cl. H01M 4/86; H01M 4/88; H01M 4/90; H01M 8/10

(52) U.S. Cl. CPC H01M 4/8652; H01M 4/8605; H01M 4/8673; H01M 4/8846; H01M 4/8885; H01M 4/9033; H01M 8/10; H01M 2004/8689

(57) ABSTRACT

The present invention includes: a porous structure containing an oxygen ion conductive material; and a coating layer disposed on the porous structure and containing an electronically conductive material, in which a content of the oxygen ion conductive material is greater than that of the electronically conductive material, and the coating layer is uniformly formed to a thickness of 20 nm or less.

### CROSS-REFERENCE TO RELATED APPLICATION

This application claims priority to and the benefit of Korean Patent Application No. 10-2023-0068478 filed in the Korean Intellectual Property Office on May 26, 2023, the entire contents of which are incorporated herein by reference.

### BACKGROUND OF THE INVENTION

### (a) Field of the Invention

The present invention relates to a cathode composite, a manufacturing method of the same, and an electrochemical cell comprising the same.

### (b) Description of the Related Art

A solid oxide fuel cell (SOFC) is a highly efficient, environmentally friendly electrochemical power generation technology that directly converts chemical energy of fuel gas into electrical energy. The SOFC have many advantages over other types of fuel cells, such as relatively inexpensive materials, relatively high tolerance for fuel impurities, hybrid power generation capability, and high efficiency, and may directly use hydrocarbon fuels without the need to reform fuel into hydrogen, resulting in simplifying a fuel cell system and lowering prices. The SOFC includes an anode where fuel such as hydrogen or hydrocarbons is oxidized, a cathode where oxygen gas is reduced to oxygen ions (02), and a ceramic solid electrolyte through which oxygen ions are conducted.

A transport of electrons and oxygen ions should occur simultaneously at the electrodes of these solid oxide fuel cells. Therefore, the electrode of the solid oxide fuel cell is made of a composite in which an electronically conductive material and an oxygen ion conductive material are mixed.

However, in the related art, a composite electrode was manufactured by simply mixing the electronically conductive material and the oxygen ion conductive material in a ratio of about 50% to 50%. However, in such a simple mixed form of the composite electrode at an equal proportions, the optimal performance of the fuel cell cannot be achieved owing to a large difference between electronic conductivity and oxygen ion conductivity. In general, oxygen ion conductivity is significantly lower than electronic conductivity, and the overall electrode performance is limited by sluggish oxygen ion transport.

To resolve this problem, various attempts have been made. For example, the proportion of oxygen ion conductive materials was increased in the composite of electronic- and ionic-conducting materials. However, in this case, the content of the electronically conductive materials is insufficient, and the electrical connection between the electronically conductive materials is lost, thereby lowering the fuel cell performance.

### SUMMARY OF THE INVENTION

The present disclosure provides a cathode composite capable of using an electronically conductive material and an oxygen ion conductive material in an optimum ratio that balances electronic conductivity and oxygen ion conductivity while maintaining electrical connectivity of the two materials, a manufacturing method of the same, and an electrochemical cell comprising the same.

According to an embodiment of the present invention, a cathode composite includes: a porous backbone structure made of an oxygen ion conductive material; and a thin coating layer of electronically conductive material on the surface of the porous backbone, in which electronic conductivity of the electronically conductive material is greater than oxygen ion conductivity of the oxygen ion conductive material, and a content of the oxygen ion conductive material is greater than that of the electronically conductive material, and the coating layer with a thickness of 20 nm or less is uniformly formed.

The porous structure may not contain an electronically conductive material.

The oxygen ion conductivity of the oxygen ion conductive material may be 0.01 to 0.2 S/cm, and the electronic conductivity of the electronically conductive material may be 50 to 1000 S/cm.

The content of the electronically conductive material may be 0.1 to 5 wt % based on a weight of the oxygen ion conductive material.

The oxygen ion conductive material may have an average particle size (D50) of 100 to 200 nm.

A thickness of the porous structure may be 10 to 50 μm.

The oxygen ion conductive material may include gadolinium-doped ceria (GDC), samarium-doped ceria (SDC), yttrium-doped ceria (YDC), lanthanum-doped ceria (LDC), yttria-stabilized zirconia (YSZ), scandia-stabilized zirconia (ScSZ), or a combination thereof.

The oxygen ion conductive material may be gadolinium-doped ceria (GDC).

The electronically conductive material may be a perovskite-based metal oxide of the following Formula 1:

ADO_{3±x} [Formula 1]

In Formula 1, A may be Sr, Sm, La, Ba, Gd, Ca or a combination thereof, D may be Co, Mn, Fe, Ni, Cu, Ti, Nb, Cr, Sc or a combination thereof, and 0≤x≤0.3.

The electronically conductive material may be samarium strontium cobalt oxide (SSC).

According to another embodiment of the present invention, a method of manufacturing a cathode composite includes: forming a porous structure containing an oxygen ion conductive material; preparing a coating solution containing an electronically conductive material precursor, urea, glycine, and a solvent; impregnating the coating solution into a pore of the porous structure; and heat-treating the porous structure impregnated with the coating solution at a temperature of 600 to 800° C. to form a coating layer containing the electronically conductive material, in which a content of the oxygen ion conductive material is greater than that of the electronically conductive material.

In the forming of the porous structure, an ink containing the oxygen ion conductive material may be applied on a substrate and then sintered at a temperature of 900 to 1200° C.

The porous structure may not contain an electronically conductive material.

In the preparing of the coating solution, the electronically conductive material precursor may be a nitrate of an element contained in the electronically conductive material.

In the preparing of the coating solution, the solvent may be a mixture of water and alcohol.

According to another embodiment of the present invention, there is provided an electrochemical cell comprising a cathode composite described above.

The electrochemical cell may be a solid oxide fuel cell or a water electrolysis cell.

According to a cathode composite according to an embodiment of the present invention, by controlling contents of an oxygen ion conductive material and an electronically conductive material in consideration of a balance of electronic and ionic conductivities, but maintaining electrical connectivity of each of the two materials, it is possible to improve performance of an electrochemical cell. The electrochemical cell may be a solid oxide fuel cell or a water electrolysis cell.

### BRIEF DESCRIPTION OF THE DRAWINGS

FIG. 1 is a conceptual diagram of a cathode composite according to an embodiment of the present invention.

FIG. 2 is an SEM image of the cathode composite manufactured according to Example 1.

FIG. 3 is a TEM image of the cathode composite manufactured according to Example 1.

FIG. 4 is an HR-TEM image of the cathode composite manufactured according to Example 1.

FIG. 5 is a graph showing results of evaluating power output characteristics of a fuel cell manufactured according to Example 1 and Comparative Example 1.

FIG. 6 is a graph showing impedance spectra of the fuel cell manufactured according to Example 1 and Comparative Example 1.

FIG. 7 is a graph showing results of evaluating lifespan characteristics of the fuel cell manufactured according to Example 1.

### DETAILED DESCRIPTION OF THE EMBODIMENTS

The terms first, second, third, and the like are used to describe, but are not limited to, various parts, components, areas, layers and/or sections. These terms are used only to distinguish a part, component, region, layer, or section from other parts, components, regions, layers, or sections. Accordingly, a first part, a component, an area, a layer, or a section described below may be referred to as a second part, a component, a region, a layer, or a section without departing from the scope of the present disclosure.

Terminologies used herein are to mention only a specific exemplary embodiment, and do not to limit the present invention. Singular forms used herein include plural forms as long as phrases do not clearly indicate an opposite meaning. The meaning “including” used in the present specification concretely indicates specific properties, areas, integer numbers, steps, operations, elements, and/or components, and is not to exclude presence or addition of other specific properties, areas, integer numbers, steps, operations, elements, and/or components thereof.

When a part is referred to as being “above” or “on” other parts, it may be directly above or on other parts, or other parts may be included in between. In contrast, when a part is referred to as being “directly above” another part, no other part is involved in between.

All terms including technical terms and scientific terms used herein have the same meaning as the meaning generally understood by those skilled in the art to which the present invention pertains unless defined otherwise. Terms defined in commonly used dictionaries are In addition interpreted as having meanings consistent with related technical literature and currently disclosed content, and are not interpreted in ideal or very formal meanings unless defined.

In addition, unless otherwise specified, % means wt %, and 1 ppm is 0.0001 wt %.

In the present specification, the term “combination(s) of these” included in the expression of the Markush format means one or more mixtures or combinations selected from the group consisting of the components described in the expression of the Markush format, and means including one or more selected from the group consisting of the components.

Hereinafter, an embodiment will be described in detail so that a person of ordinary skill in the art to which the present invention pertains can easily implement the present invention. However, the present invention may be implemented in many different forms and is not limited to the embodiments described herein.

### 1. Cathode Composite

According to an embodiment of the present invention, a cathode composite includes: a porous structure containing an oxygen ion conductive material; and a coating layer deposited on the porous structure and containing an electronically conductive material, in which electronic conductivity of the electronically conductive material is greater than oxygen ion conductivity of the oxygen ion conductive material, and a content of the oxygen ion conductive material is greater than that of the electronically conductive material, and the coating layer is uniformly formed to a thickness of 20 nm or less.

The cathode composite according to an embodiment of the present invention may be used as a cathode of an electrochemical cell, and the electrochemical cell may be a solid oxide fuel cell or a water electrolysis cell.

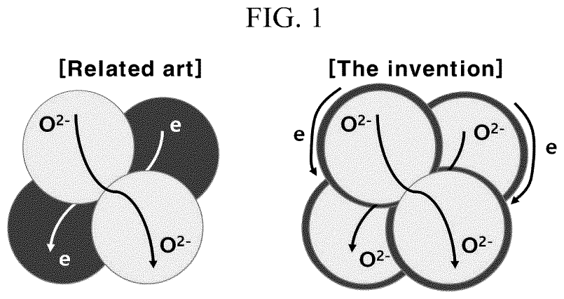

FIG. 1 is a conceptual diagram of a cathode composite according to an embodiment of the present invention.

Referring to FIG. 1, the cathode composite according to an embodiment of the present invention includes an electronically conductive material and an oxygen ion conductive material. This is to allow the flow of electrons and oxygen ions to occur simultaneously to optimally drive the solid oxide fuel cell or water electrolysis cell.

In this case, the electronic conductivity of the electronically conductive material is greater than the oxygen ion conductivity of the oxygen ion conductive material. However, the conventional cathode composite was in the form of a mixture including the electronically conductive material and the oxygen ion conductive material at equal content levels without balancing the conductivities of the two materials. The cathode composite of the composition had the problem of limiting the output characteristics of the electrochemical cell due to the low ionic conductivity of the oxygen ion conductive material.

Meanwhile, attempts were made to increase the content of the oxygen ion conductive material in the cathode composite to overcome the above problem. However, in this case, there was a problem in that the conduction paths for electrons are disconnected as the content of the electronically conductive material decreased.

To solve this problem, the content of the oxygen ion conductive material in the cathode complex should increase as much as possible to maintain a balance between the electronic conductivity and the oxygen ion conductivity, and at the same time, maintain the electrical connection between the electronically conductive materials.

Accordingly, the cathode composite according to an embodiment of the present invention is not a composite in the form of a simple mixture of an electron conductive material and an ion conductive material, but has a coating layer structure that is deposited on a support containing the oxygen ion conductive material and contains the electronically conductive material.

Through this structure, it is possible to sufficiently increase the content of the oxygen ion conductive material having relatively low conductivity to balance the electronic conductivity and the oxygen ion conductivity, as well as to maintain good electrical connectivity of the electronically conductive material forming the coating layer. Through this, it is possible to solve both of the above-mentioned problems and improve the electrochemical characteristics, such as the power output characteristics of the electrochemical cell.

In particular, the coating layer may be uniformly formed with a very thin thickness of 20 nm or less. As the thickness of the coating layer is very thin and uniform, there is an advantage in that an overall uniform electron movement path may be formed. More specifically, the thickness of the coating layer may be 15 nm, 10 nm, or 7 nm or less.

In order to more preferably implement the above effect, the porous structure may not contain the electronically conductive material. That is, the porous structure may contain only the oxygen ion conductive material.

The oxygen ion conductivity of the oxygen ion conductive material may be 0.01 to 0.2 S/cm.

In addition, the electronic conductivity of the electronically conductive material may be 50 to 1000 S/cm.

The content of the electronically conductive material may be 0.1 to 5 wt % based on a weight of the oxygen ion conductive material. When the content of the electronically conductive material satisfies the above range, the balance between the electronic conductivity and the oxygen ion conductivity is preferably controlled, so the electrochemical cell performance improvement effect may be preferably implemented.

The oxygen ion conductive material may have an average particle size (D50) of 100 to 200 nm. When the average particle size of the oxygen ion conductive material is too small, there may be a problem of poor thermal stability, and when the average particle size of the oxygen ion conductive material is too large, there may be a problem of insufficient electrochemical reaction sites. Therefore, the electrochemical cell performance improvement effect may be preferably implemented when the average particle size of the oxygen ion conductive material satisfies the above range.

In this specification, the average particle size (D50) may be defined as a particle size corresponding to 50% of a volume accumulation amount in a particle size distribution curve of particles. The average particle size (D50) may be measured using, for example, a laser diffraction method.

The thickness of the porous structure may be 10 to 50 μm. When the thickness of the porous structure is too thin, there may be a problem of insufficient electrochemical reaction sites, and when the thickness of the porous structure is too thick, there may be a problem of restrictions on the gas diffusion. Therefore, when the thickness of the porous structure satisfies the above range, the electrochemical cell performance improvement effect may be preferably implemented.

Specifically, the oxygen ion conductive material may include gadolinium-doped ceria (GDC), samarium-doped ceria (SDC), yttrium-doped ceria (YDC), lanthanum-doped ceria (LDC), yttria-stabilized zirconia (YSZ), scandia-stabilized zirconia (ScSZ), or a combination thereof, but is not limited thereto.

More specifically, the oxygen ion conductive material may be the gadolinium-doped ceria (GDC).

More specifically, the electronically conductive material may be a perovskite-based metal oxide of the following Formula 1.

ADO_{3±x} [Formula 1]

In Formula 1, A may be Sr, Sm, La, Ba, Gd, Ca or a combination thereof, D may be Co, Mn, Fe, Ni, Cu, Ti, Nb, Cr, Sc or a combination thereof, and 0≤x≤0.3.

More specifically, the electronically conductive material may be samarium strontium cobalt oxide (SSC).

### 2. Method of Manufacturing Cathode Composite

According to another embodiment of the present invention, a method of manufacturing a cathode composite includes: forming a porous structure containing an oxygen ion conductive material; preparing a coating solution containing an electronically conductive material precursor, urea, glycine, and a solvent; impregnating the coating solution into a pore of the porous structure; and heat-treating the porous structure impregnated with the coating solution at a temperature of 600 to 800° C. to form a coating layer including the electronically conductive material, in which a content of the oxygen ion conductive material is greater than that of the electronically conductive material.

Hereinafter, the method for manufacturing a cathode composite according to another embodiment of the present invention will be described step by step.

First, the porous structure containing the oxygen ion conductive material is formed.

More specifically, in the forming of the porous structure, an ink containing the oxygen ion conductive material may be applied on a substrate and then sintered at a temperature of 900 to 1200° C.

The substrate may be appropriately selected depending on the mode in which the cathode composite according to the present invention is used. For example, the substrate may be a solid electrolyte of the solid oxide fuel cell.

The application is not particularly limited as long as it is a conventional method in the art, but more specifically, may be performed by a screen printing method. By performing the application using the screen printing method, there may be the advantage of easy scale up and mass production.

The description of the oxygen ion conductive material is the same as described above, and therefore, will be omitted.

In this case, the porous structure may not contain an electronically conductive material. The technical significance thereof has been described above, which will be omitted.

Next, a coating solution containing an electronically conductive material precursor, urea, glycine, and a solvent is prepared.

In this case, the electronically conductive material precursor may be a nitrate of an element contained in the electronically conductive material. For example, when the electronically conductive material is samarium strontium cobalt oxide (SSC), the electronically conductive material precursor may contain samarium nitrate, strontium nitrate, and cobalt nitrate.

The description of the electronically conductive material is the same as described above, and therefore, will be omitted.

The solvent is not particularly limited as long as it may dissolve the electronically conductive material precursor. More specifically, the solvent may be a mixture of water and alcohol. In this case, water may dissolve the electronically conductive material precursor, and alcohol may lower a surface tension of a coating solution so that the coating solution may be impregnated into fine pores. The alcohol may be, for example, ethanol, but is not limited thereto.

The urea serves as a complexing agent when preparing the coating solution, and when heat treatment is performed after impregnation, which will be described later, urea may decompose and precipitate cations.

In particular, the glycine may serve as an auxiliary complexing agent to form a pure perovskite phase at a low process temperature.

In addition, the content of the electronically conductive material precursor may be controlled so that the electronically conductive material in the cathode composite is 0.1 to 5 wt % based on the weight of the oxygen ion conductive material. The technical significance of controlling the electronically conductive material content is the same as described above, which will be omitted.

Next, the coating solution is impregnated into the pores of the porous structure.

Next, the porous structure impregnated with the coating solution is heat-treated at a temperature of 600 to 800° C. to form the coating layer containing the electronically conductive material.

Through this, the coating layer is firmly formed on the surface of the porous structure to form the cathode composite together with the porous structure serving as a backbone of the support.

In particular, the heat treatment temperature may be 600 to 700° C., and more specifically, 630 to 670° C. When the heat treatment temperature is too low, there may be a problem in that the perovskite phase is not formed, and when the heat treatment temperature is too high, there may be problems in that interdiffusion or chemical side reactions occur. Therefore, when the heat treatment temperature satisfies the above range, the extremely thin and uniform coating layer may be formed on the surface of the porous structure.

### 3. Electrochemical Cell

According to another embodiment of the present invention, there is provided an electrochemical cell comprising a cathode composite described above.

The electrochemical cell may be a solid oxide fuel cell or a water electrolysis cell.

First, the solid oxide fuel cell will be described.

The solid oxide fuel cell consists of a cathode including the above-described cathode composite; an anode; and a solid electrolyte layer between the cathode composite and the anode.

The solid electrolyte layer should have dense structure. To this end, sintering may be performed at high temperature for a long time. In this case, the sintering can be performed at about 1,450 to 1,550° C. for 6 to 8 hours as the sintering conditions.

The cathode composite may reduce oxygen gas into oxygen ions, and maintain a constant oxygen partial pressure by continuously flowing air through the cathode composite.

The solid electrolyte layer should be dense to prevent air and fuel from mixing, and should have high oxygen ion conductivity and low electronic conductivity. In addition, since the solid electrolyte layer has a cathode and an anode with a very large difference in oxygen partial pressure positioned on both sides thereof, it is necessary to maintain the above physical properties in a wide oxygen partial pressure range.

As such a solid electrolyte material, zirconia-based, LSGM ((La, Sr)(Ga, Mg)O₃)-based materials, etc., commonly used in the relevant technical field may be used. For example, stabilized zirconia systems such as yttria stabilized zirconia (YSZ) and scandia stabilized zirconia (ScSZ) may be usefully used. In addition, in the case of the LSGM ((La, Sr)(Ga, Mg)O₃) system, an anode functional layer such as GDC may be further included to prevent reaction with Ni.

The thickness of the solid electrolyte layer may generally be 10 nm to 100 μm, and more specifically, 100 nm to 50 μm.

In the anode, fuel is electrochemically oxidized, and water vapor is formed as a byproduct. Therefore, an anode should catalyze fuel oxidation reaction, be chemically stable in reducing atmosphere and have a similar thermal expansion coefficient with the electrolyte material. The anode may include a cermet in which metal is mixed with a solid oxide electrolyte material. For example, when YSZ is used as an electrolyte, a Ni/YSZ composite (ceramic-metallic composite) may be used as the anode. In addition, Ru/YSZ cermet, pure metals such as Ni, Co, Ru, and Pt, or the like may be used as anode materials, but are not limited thereto. The anode may further include activated carbon, if necessary. The anode preferably has sufficient porosity for facile gas diffusion.

The thickness of the anode may be generally 10 to 1000 μm. For example, the thickness of the anode may be 5 to 100 μm.

According to an embodiment, the solid oxide fuel cell may further include an electric current collection layer including an electron conductor on at least one side of the cathode composite, for example, an outer side of the cathode composite. The electric current collection layer may serve as a current collector to collect electricity in the cathode configuration.

The electric current collection layer may contain at least one selected from the group consisting of, for example, lanthanum cobalt oxide (LaCoO₃), lanthanum strontium cobalt oxide (LSC), lanthanum strontium cobalt iron oxide (LSCF), lanthanum strontium cobalt manganese oxide (LSCM), lanthanum strontium manganese oxide (LSM), and lanthanum strontium iron oxide (LSF). The electric current collection layer may be made of the materials listed above either alone or in a mixture of two or more. In addition, it is also possible to use these materials to form a single layer or a stacked structure of two or more layers.

The solid oxide fuel cell may be manufactured using common methods known in various literature in the art, and therefore, a detailed description thereof will be omitted here. In addition, the solid oxide fuel cell may be applied to various structures such as a cylindrical (tubular) stack, a flat tubular stack, and a planar type stack.

The fuel cell according to an embodiment of the present invention prevents thermal expansion mismatch of a cathode active material while maintaining low resistance to minimize inter-layer thermal maladaptation and improve stability, thereby increasing the durability of the fuel cell.

The fuel cell can be operated at a temperature of 800° C. or lower, for example, in the temperature range of 550 to 750° C. or 600 to 750° C. As a result, by suppressing the thermal expansion mismatch of the cathode active material while maintaining the high ion conductivity at low temperature to minimize the inter-layer thermal maladaptation of the cell within the solid oxide fuel cell and improve the thermal stability, it is possible to increase the durability of the solid oxide fuel cell.

Next, the water electrolysis cell will be described.

The water electrolysis cell specifically includes electrolyte; an anode located on one surface of the electrolyte and generating oxygen gas; and a cathode located on the other surface of the electrolyte and generating hydrogen gas by decomposing steam.

At the anode, the oxidation reaction may occur, and oxygen gas formed by decomposing steam may be generated.

At the cathode, the reduction reaction may occur, and hydrogen gas formed by decomposing steam may be generated.

Each of these electrode reactions is as shown in Chemical Equation 1 below.

Anode: O²⁻→½O₂+2e

Cathode: H₂O+2e→H₂+O²⁻

Overall: H₂O→H₂+½O₂ [Chemical Equation 1]

The same materials described earlier for solid oxide fuel cells can also be used for electrolysis cells. The anode and cathode of solid oxide fuel cells are referred to as the cathode and anode, respectively.

Hereinafter, embodiments of the present invention will be described in more detail through examples. However, the following Examples are only exemplary embodiments of the present invention, and the present invention is not limited to the following Examples.

### Example 1

### (1) Manufacturing of Cathode Composite

An ink containing Gd_{0.1}Ce_{0.9}O_{1.95} (GDC) with an average particle size (D50) of 100 nm was applied on a YSZ electrolyte using a screen printing process and then sintered at a temperature of 1000° C. to form a porous structure.

Thereafter, samarium nitrate, strontium nitrate, cobalt nitrate, urea, and glycine were dissolved in the solvent composed of water and ethanol to prepare a coating solution.

Thereafter, the coating solution is impregnated (injected) into the pores of the porous structure.

Thereafter, the porous structure impregnated with the coating solution was heat-treated at a temperature of 650° C. to prepare a cathode composite formed with a (Sm_{0.5}Sr_{0.5})CoO₃ coating layer.

In this case, the content of (Sm_{0.5}Sr_{0.5})CoO₃—, which is an electronically conductive material, was 0.5 wt % based on the weight of Gd_{0.1}Ce_{0.9}O_{1.95} (GDC), which is an oxygen ion conductive material.

### (2) Manufacturing of Fuel Cell

A fuel cell was manufactured by forming a Ni-YSZ anode with a thickness of approximately 400 μm and a cathode on an YSZ electrolyte with a thickness of approximately 5 μm.

### Comparative Example 1

Comparative Example was performed in the same way as Example 1 except that the cathode was manufactured using a simple mixture composite of 50 wt % La_{0.6}Sr_{0.4}Co_{0.2}Fe_{0.8}O₃ (LSCF)-50 wt % 50 wt % Gd_{0.1}Ce_{0.9}O_{1.95} (GDC) to manufacture a cathode composite and a fuel cell.

### Experimental Example 1: Cathode Composite Image Analysis

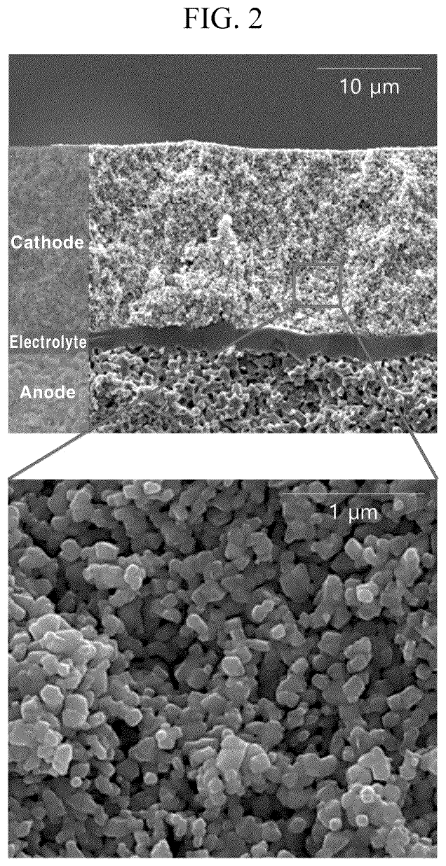

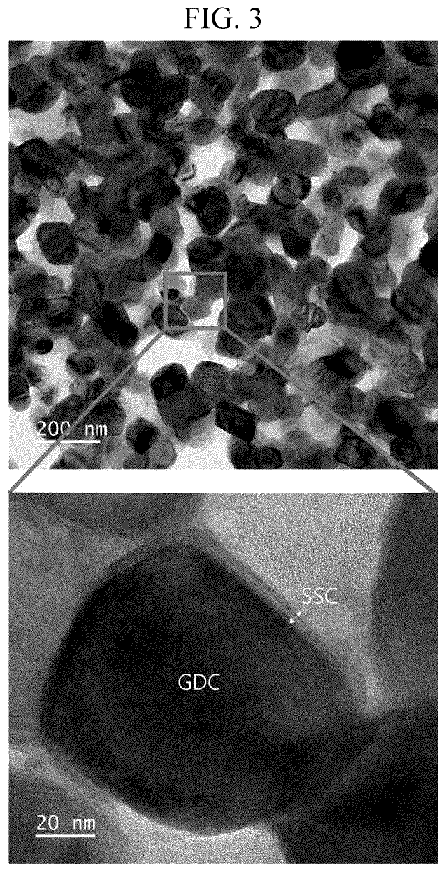

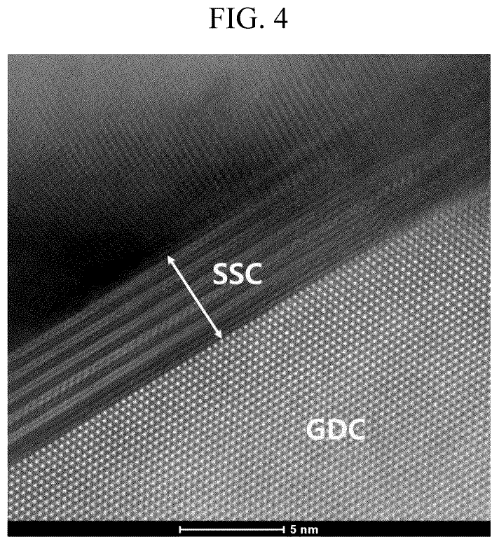

To analyze the structure of the cathode composite prepared according to Example 1, SEM (scanning electron microscope) and TEM (transmission electron microscope) images were observed, which were illustrated in FIGS. 2 to 4. Specifically, FIG. 2 is an SEM image of the cathode composite manufactured according to Example 1. FIG. 3 is a TEM image of the cathode composite manufactured according to Example 1. FIG. 4 is an HR-TEM image of the cathode composite manufactured according to Example 1.

Referring to FIG. 2, it was confirmed that the cathode composite (or porous structure) of Example 1 had a thickness of about 20 μm and had a porous structure with pores formed on the surface.

Referring to FIG. 3, it could be confirmed that the cathode composite of Example 1 had a very thin and uniform SSC coating layer formed on the surface of the GDC porous structure in the form of a thin film.

Referring to FIG. 4, in particular, it was confirmed that the SSC coating layer was very thin and uniform, with a thickness of about 5 nm.

### Experimental Example 2: Evaluation of Fuel Cell Electrochemical Characteristics

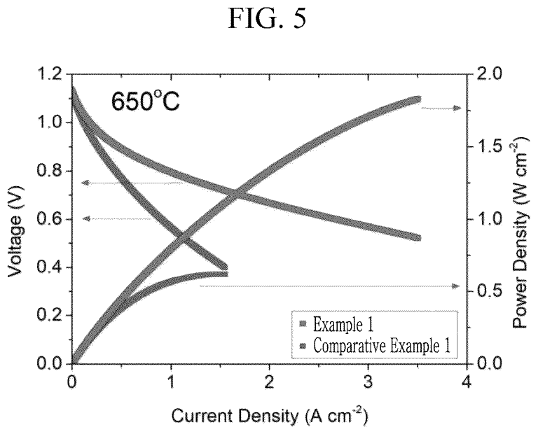

The electrochemical characteristics of the fuel cell manufactured according to Example 1 and Comparative Example 1 were evaluated, which was illustrated in FIGS. 5 to 7. The specific experimental method is as follows.

### (1) Evaluation of Power Generation Characteristics

At 650° C., 200 sccm of hydrogen was supplied to the anode and 200 sccm of air was supplied to the cathode, and the power generation characteristics were evaluated by measuring a current-voltage curve, which was illustrated in FIG. 5.

### (2) Evaluation of Resistance Characteristics

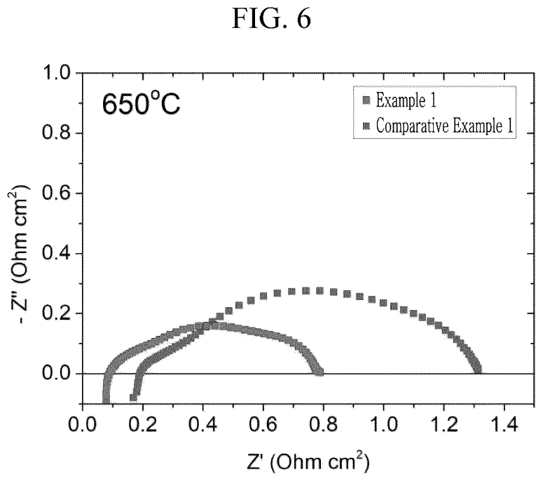

At 650° C., 200 sccm of hydrogen was supplied to the anode and 200 sccm of air was supplied to the cathode, and the resistance characteristics were evaluated by measuring impedance at 0.1 to 105 Hz, which was illustrated in FIG. 6.

### (3) Evaluation of Life Characteristics

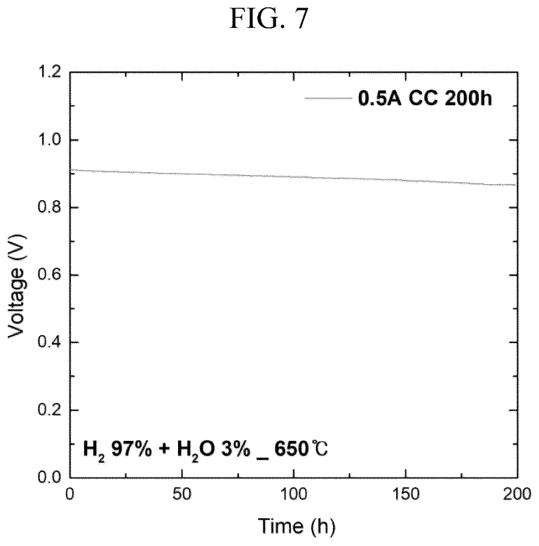

At 650° C., 200 sccm of hydrogen was supplied to the anode and 200 sccm of air was supplied to the cathode, and the change in voltage was measured while a current of 0.5 A/cm2 was applied to evaluate the lifespan characteristics, which was illustrated in FIG. 7.

Referring to FIG. 5, in the case of Example 1, it could be confirmed that the current density was very high at the same voltage compared to Comparative Example 1, thereby confirming that the power output characteristics were improved. In particular, compared to Comparative Example 1, it could be confirmed that the maximum output at 650° C. was improved by more than three times from 0.6 W/cm2 to 1.8 W/cm2.

Referring to FIG. 6, it could be confirmed that in Example 1, both ohmic resistance and polarization resistance were greatly reduced compared to Comparative Example 1.

The above results may be interpreted as a result of the fact that, in the case of the example, the contents of the oxygen ion conductive material and the electronically conductive material were controlled to well balance their different conductivities, and at the same time, the electrical connection of the electronically conductive material was maintained well.

Meanwhile, referring to FIG. 7, in the case of Example 1, it was confirmed that the cell operated stably without significant deterioration even after 200 hours of long-term evaluation under the constant current of 0.5 A/cm2 at 650° C. Although preferred embodiments of the present invention have been described above, the present invention is not limited thereto, and the present invention can be variously modified within the scope of the claims, the detailed description of the invention, and the appended drawings, and it is natural that various modifications also fall within the scope of the present invention.

Therefore, the substantial scope of the present invention will be defined by the claims and equivalents thereof.

What is claimed is:

1. A cathode composite, comprising:
a porous structure containing an oxygen ion conductive material; and a coating layer disposed on the porous structure and containing an electronically conductive material,
wherein electronic conductivity of the electronically conductive material is greater than oxygen ion conductivity of the oxygen ion conductive material, and a content of the oxygen ion conductive material is greater than that of the electronically conductive material, and
the coating layer is uniformly formed to a thickness of 20 nm or less.

2. The cathode composite of claim 1, wherein:
the porous structure does not contain an electronically conductive material.

3. The cathode composite of claim 1, wherein:
the oxygen ion conductivity of the oxygen ion conductive material is 0.01 to 0.2 S/cm, and the electronic conductivity of the electronically conductive material is 50 to 1000 S/cm.

4. The cathode composite of claim 1, wherein:
the content of the electronically conductive material is 0.1 to 5 wt % based on a weight of the oxygen ion conductive material.

5. The cathode composite of claim 1, wherein:
the oxygen ion conductive material has an average particle size (D50) of 100 to 200 nm.

6. The cathode composite of claim 1, wherein:
a thickness of the porous structure is 10 to 50 μm.

7. The cathode composite of claim 1, wherein:
the oxygen ion conductive material includes gadolinium-doped ceria (GDC), samarium-doped ceria (SDC), yttrium-doped ceria (YDC), lanthanum-doped ceria (LDC), yttria-stabilized zirconia (YSZ), scandia-stabilized zirconia (ScSZ), or a combination thereof.

8. The cathode composite of claim 1, wherein:
the oxygen ion conductive material is gadolinium-doped ceria (GDC).

9. The cathode composite of claim 1, wherein:
the electronically conductive material is a perovskite-based metal oxide of the following Formula 1:
ADO_{3±x} [Formula 1]
in Formula 1, A is Sr, Sm, La, Ba, Gd, Ca or a combination thereof, D is Co, Mn, Fe, Ni, Cu, Ti, Nb, Cr, Sc or a combination thereof, and 0≤x≤0.3.

10. The cathode composite of claim 1, wherein:
the electronically conductive material is samarium strontium cobalt oxide (SSC).

11. A method of manufacturing a cathode composite, comprising:
forming a porous structure containing an oxygen ion conductive material;
preparing a coating solution containing an electronically conductive material precursor, urea, glycine, and a solvent;
impregnating the coating solution into a pore of the porous structure; and
heat-treating the porous structure impregnated with the coating solution at a temperature of 600 to 800° C. to form a coating layer containing the electronically conductive material,
wherein a content of the oxygen ion conductive material is greater than that of the electronically conductive material.

12. The method of claim 11, wherein:
in the forming of the porous structure,
a solution containing the oxygen ion conductive material is applied on a substrate and then sintered at a temperature of 900 to 1200° C.

13. The method of claim 11, wherein:
in the forming of the porous structure,
the porous structure does not contain the electronically conductive material.

14. The method of claim 11, wherein:
in the preparing of the coating solution,
the electronically conductive material precursor is a nitrate of an element contained in the electronically conductive material.

15. The method of claim 11, wherein:
in the preparing of the coating solution,
the solvent is a mixture of water and alcohol.

16. An electrochemical cell comprising a cathode composite of claim 1.

17. The electrochemical cell of claim 16, wherein:
the electrochemical cell is a solid oxide fuel cell or a water electrolysis cell.
